(19) United States
(12) Patent Application Publication
(10) Pub. No.: US 2013/0109351 A1
(43) Pub. Date: May 2, 2013

(54) AUTHENTICATION SYSTEM, AUTHENTICATION METHOD AND AUTHENTICATION SERVER

(71) Applicant: The Bank of Tokyo - Mitsubishi UFJ, Ltd., Tokyo (JP)

(72) Inventor: Takaya KATO, Tokyo (JP)

(73) Assignee: THE BANK OF TOKYO - MITSUBISHI UFJ, LTD., Tokyo (JP)

(21) Appl. No.: 13/658,287

(22) Filed: Oct. 23, 2012

(30) Foreign Application Priority Data
Nov. 2, 2011 (JP) 2011-240949

(51) Int. Cl. H04W 12/06

(52) U.S. Cl. 455/411

(57) ABSTRACT

An authentication system includes a movable terminal, a communication server connected with the terminal by wireless communication managing predicted location data of the terminal, a service usage device allowing a service provider to provide a service to a user of the terminal, and a service provision server connected with the service usage device and the communication server and managing location data of the service usage device. The service provision server includes a service usage device connection part connected with the service usage device, receiving an authentication request and installment location data of the service usage device, a communication server connection part communicating with the communication server, a predicted location data acquisition part obtaining predicted location data from the communication server; a user data database storing terminal identification data, and an authentication part performing authentication based on the installment location data and the predicted location data responding to the authentication request.

### CROSS-REFERENCE TO RELATED APPLICATIONS

This application is based upon and claims the benefit of priority from the prior Japanese Patent Application No. 2011-240949, filed on Nov. 2, 2011; the entire contents of which are incorporated herein by reference.

### FIELD

The present invention is related to a device and a method which perform authentication, more specifically, the present invention is related to a device and a method which perform authentication using location data of a terminal.

### BACKGROUND

In recent years, mobile phones have become widely common and smartphones which are mobile phones including a mobile data terminal function, are rapidly becoming popular. Smartphones not only include functions such as voice calling and mail but also include schedules, personal information management, browser functions, business applications, games, multimedia players and can also be used by installing other various functions.

In addition, not only is it possible to use mobile communication systems such as 3G in a smartphone but it is also becoming widespread to include functions for performing data communication by connecting to wireless LAN access points within a wireless LAN which uses the IEEE802.11 series communication standard.

While smartphones often include functions for obtaining location data, not only is it possible to obtain location data using GPS such as conventional mobile phones or PHS, but it is also possible to specify a location using the MAC address of a wireless LAN access point and its electrical field strength when connected to a wireless LAN access point.

Authentication systems are being developed which use the location data of these types of mobile phones or PHS (for example, patent document 1 [Japanese Laid Open Patent 2002-232955]). However, these authentication systems may not be easy to use due to the state of a signal etc.

Nevertheless, unlawful access by a third party when using a non-contact (non face-to-face) service such as bank trading via an ATM or Internet banking still exists as a problem. While biometric authentication such as finger print or vein authentication is being varied out in order to prevent such impersonation, biometric authentication is still not widely used.

Thus, a technology which can prevent unlawful use of a service by impersonation which is highly accurate and does not increase the burden on users by using a common means is desired.

The present invention attempts to provide an authentication system and authentication method which can prevent unlawful use of a service by impersonation, which is highly accurate and does not require complex procedures to be performed on the client side.

### SUMMARY

An authentication system related to one embodiment of the present invention includes a movable terminal, a communication server connected with the terminal by wireless communication managing predicted location data of the terminal, a service usage device allowing a service provider to provide a service to a user of the terminal, and a service provision server connected with the service usage device and the communication server and managing location data of the service usage device, wherein the service provision server includes a service usage device connection part connected with the service usage device and receiving an authentication request from the user and installment location data of the service usage device from the service usage device, a communication server connection part communicating with the communication server, a predicted location data acquisition part obtaining predicted location data from the communication server, a user data database storing terminal identification data of the user, the user being a service user, and an authentication part performing authentication based on the installment location data and the predicted location data in response to the authentication request.

In addition, an authentication system related to one embodiment of the present invention includes a movable terminal obtaining present location data, a communication server connected with the terminal by wireless communication managing predicted location data of the terminal, and a service provision server connected with the communication server, wherein the service provision server includes, a service provision part receiving an authentication request from a user and providing a service to the user; a location data acquisition part obtaining the present location data of the terminal, a communication server connection part communicating with the communication server, a predicted location data acquisition part obtaining predicted location data from the communication server, a user data database storing terminal identification data of the user, the user being a service user, and an authentication part performing authentication based on the installment location data and the predicted location data in response to the authentication request.

The predicted location data may be a predicted location in a predetermined time period of the terminal.

In addition, an authentication system related to another embodiment of the present invention includes a movable terminal obtaining present location data, a communication server connected with the terminal by wireless communication, a service usage device allowing a service provider to provide a service to a user of the terminal, and a service provision server connected with the service usage device and the communication server and managing location data of the service usage device, wherein the service provision server includes, a service usage device connection part connected with the service usage device and receiving an authentication request from the user and installment location data of the service usage device from the service usage device, a location data acquisition part obtaining the present location data of the terminal, a communication server connection part communicating with the communication server, a user data database storing terminal identification data of the user, the user being a service user; and an authentication part performing authentication based on the installment location data and the predicted location data in response to the authentication request.

The communication server may also manage predicted location data of the terminal, the service provision server may include a predicted location data acquisition part obtaining the predicted location data from the communication server, and the authentication part may perform authentication based on the present location data, the installment location data and the predicted location data.

The terminal may include a registration part registering the predicted location data in advance by an input of a user of the terminal. In addition, the terminal may obtain location data of the present location via communication with a wireless LAN device.

In addition, a service provision server related to one embodiment of the present invention connected with a communication server managing predicted location data of a terminal and a service usage device allowing a service provider to provide a service to a user of the terminal, includes a service usage device connection part communicating with the service usage device and receiving an authentication request from the service usage device and installment location data of the service usage device, a communication server connection part communicating with the communication server, a predicted location data acquisition part obtaining predicted location data from the communication server, a user data database storing terminal identification data of the user, the user being a service user, and an authentication part performing authentication based on the installment location data and the predicted location data in response to the authentication request.

In addition, a service provision server related to another embodiment of the present invention connected with a communication server and managing predicted location data of a terminal, includes a service provision part receiving an authentication request from the terminal of a user and providing a service to the user of the terminal, a location data acquisition part obtaining the present location data of the terminal, a communication server connection part communicating with the communication server, a predicted location data acquisition part obtaining predicted location data from the communication server, a user data database storing terminal identification data of the user, the user being a service user, and an authentication part performing authentication based on the present location data and the predicted location data in response to the authentication request.

In addition, a service provision server according to another embodiment of the present invention connected with a communication server and managing present location data of a terminal and a service usage device allowing a service provider to provide a service to a user of the terminal, includes a service usage device connection part communicating with the service usage device and receiving an authentication request from the service usage device and installment location data of the service usage device, a communication server connection part communicating with the communication server, a location data acquisition part obtaining the present location data from the communication server, a user data database storing terminal identification data of the user, the user being a service user; and an authentication part performing authentication based on the installment location data and the present location data in response to the authentication request.

The service provision server may further include a predicted location data acquisition part obtaining predicted location data from the communication server; and the authentication part may perform authentication based on the present location data, the installment location data and the predicted location data. In addition, the predicted location data may be data registered in advance by a user of the terminal.

In addition, an authentication method related to one embodiment of the present invention in an authentication system including a movable terminal, a communication server connected with the terminal by wireless communication and managing schedule data of the terminal, a service usage device allowing a service provider to provide a service to a user of the terminal, and a service provision server connected with the service usage device and the communication server and managing location data of the service usage device, wherein the service provision server communicates with the service usage device and receives an authentication request and installment location data, communicates with the communication server and receives predicted location data of the terminal and performs authentication based on the installment location data and the predicted location data in response to the authentication request.

In addition, an authentication method related to another embodiment of the present invention in an authentication system including a movable terminal, a communication server connected with the terminal by wireless communication and managing schedule data of the terminal, and a service provision server connected with the communication server and managing location data of a service usage device, wherein the service provision server receives an authentication request from the terminal, communicates with the communication server and receives predicted location data and present location data of the terminal and performs authentication based on the predicted location data and the present location data in response to the authentication request.

In addition, an authentication method related to another embodiment of the present invention in an authentication system including a movable terminal which can understand present location data, a communication server connected with the terminal by wireless communication, a service usage device allowing a service provider to provide a service to a user of the terminal, and a service provision server connected with the service usage device and the communication server and managing location data of the service usage device, wherein the service provision server communicates with the service usage device and receives an authentication request and installment location data, communicates with the communication server and receives present location data of the terminal and performs authentication based on the installment location data and the present location data in response to the authentication request.

### BRIEF DESCRIPTION OF DRAWINGS

FIG. 1 is a functional block diagram showing the structure of an authentication system related to one embodiment of the present invention;

FIG. 2 is a functional block diagram showing the structure of an authentication system related to another embodiment of the present invention;

FIG. 3 is a functional block diagram showing the structure of an authentication system related to another embodiment of the present invention;

FIG. 4 is a flowchart for explaining the processes of an authentication method related to one embodiment of the present invention;

FIG. 5 is a flowchart for explaining the processes of an authentication method related to another embodiment of the present invention; and

FIG. 6 is a flowchart for explaining the processes of an authentication method related to another embodiment of the present invention.

### DESCRIPTION OF EMBODIMENTS

### First Embodiment

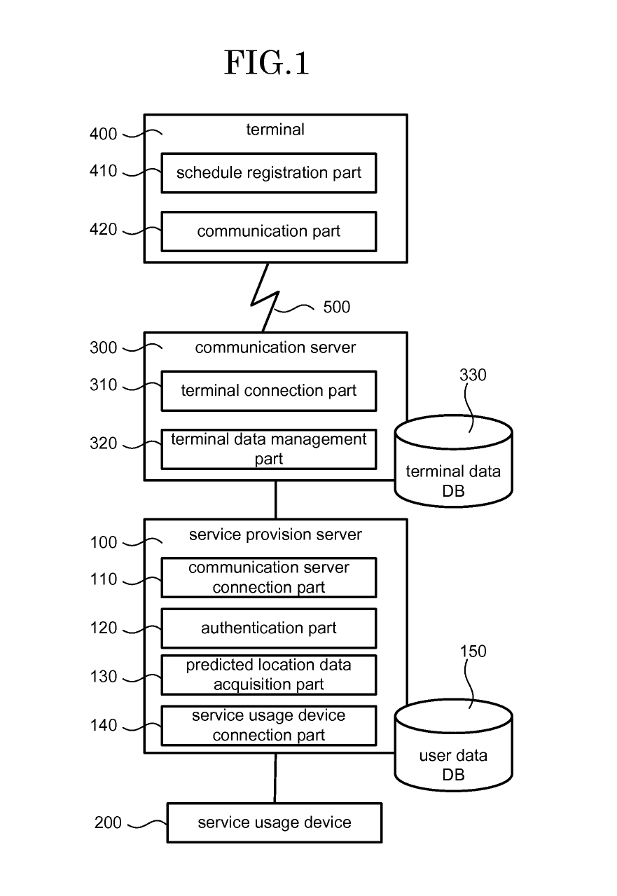

FIG. 1 is a functional block diagram which shows the structure of an authentication system related to one embodiment of the present invention.

FIG. 1 includes a service provision server 100, a service usage device 200, a communication server 300 and a terminal 400.

The service provision server 100 is a server for providing various services to a user who uses the services of a service provider and who is a user who possesses the terminal 400. Bank trading is an example of such a service but not limited to this. The service provision server 100 may be physically comprised of one server or a plurality of servers clustered together. In addition, the server may also be a cloud computer which is comprised of a plurality of applications, platforms and infrastructure.

The service usage device 200 is connected to the service provision server 100 and is a terminal which actually provides services to a service user. For example, the terminal may be an ATM for use in bank trading.

The communication server 300 communicates with the terminal 400 and manages the terminal. For example, the server 300 may be a server of a carrier in the case where the terminal is a mobile phone.

The terminal 400 is a communication terminal which can perform wireless communication. For example, a mobile phone can be given as an example or more preferably, a smartphone which is a terminal which is capable of wireless LAN communication.

The service provision server 100 includes a communication server connection part 110, an authentication part 120, a predicted location data acquisition part 130 and a service usage device connection part 140.

The communication server connection part 110 is a component for connecting the communication server 300 and exchanges data with the communication server 300.

The authentication part 120 is a component which receives a message from the service usage device 200 and performs authentication. This message includes an authentication request which is performed in the case where a service user attempts to receive provision of a service in the service usage device 200.

The predicted location data acquisition part 130 obtains predicted location data of the terminal 400 from the communication server. The obtained predicted location data is used by the authentication part 120 which is described in detail below.

The service usage device connection part 140 is a component for connecting with the service usage device 200. The service usage device connection part 140 receives a message from the service usage device and also manages data such as the installment location of the service usage device 200.

A user data database 150 correlates the terminal 400 with a service user and stores data which can specify the terminal 400 used by a service user as terminal identification data. The user data database 150 correlates identification data which identifies a service uses within the service provision server 100 with identification data which identifies this service user or a terminal held by this service user within the communication server 300 and stores the data.

The communication server 300 includes a terminal connection part 310, a terminal data management part 320 and a terminal data database 330.

The terminal connection part 310 is an interface which communicates with the terminal 400 and sends and receives data using packet communication etc with the terminal 400. The communication method of data with the terminal 400 is not particularly limited and various types of communication service, wireless access service and wireless packet communication methods may be used.

The terminal data management part 320 is a component which manages location data and schedule data of the terminal 400 which is received from the terminal 400 in the terminal connection part 310, and registers schedule data of the terminal 400 in the terminal data database 330. Schedule data is data where a terminal is predicted to be in a certain time period, that is, data in which a predetermined time period and location data within this time period, that is, predicted location data are correlated. Specifically, the predicted location data may be input as an address by a user of the terminal 400 or input by specifying a location on a map. In the terminal data management part 320, the location data input by a user may be converted to coordinate data and stored in the terminal data database 330.

Schedule data is correlated with identification data which identifies a terminal or a user of a terminal within the communication server 300 by the terminal data management part 320 and registered in the terminal data database 330. In addition, schedule data which is correlated with identification data and stored is provided to the service provision server 100 in response to a request which includes this identification data from the predicted location data acquisition part 130 of the service provision server 100 to the terminal data management part 320.

The terminal 400 includes a schedule registration part 410 and a communication part 420.

The schedule registration part 410 is an application which manages a schedule on a terminal. For example, the schedule registration part 410 may be an application which can register, amend or delete plans such as a calendar or To Do list. Plans can be registered in certain time units in the schedule registration part 410 and includes a function for registering a location such as where the user is within a certain time band.

The communication part 420 sends and receives data between the communication server 300 using packet communication etc. When communicating, connection may be made with the communication server 300 using the Internet or a dedicated line via a base station connected with the communication server or a device for wireless access services.

In the system related to one embodiment of the present invention, authentication using schedule data is performed in the authentication part 120 when a user of terminal 400 attempts to use the service usage device 200.

That is, location data which specifies the installment location of the service usage device 200 is obtained as follows. Location data of the service usage device 200 and identification data of a service user are included in a message which is sent from the service usage device 200. Then, location data included in the message sent from the service usage device 200 is obtained when an authentication request for use of a service is received from the service usage device 200 via the service usage device connection part 140 of the service provision server 100. Furthermore, the service provision server 100 may also include a database which stores location data for each service usage device 200 with a symbol for identifying a service usage device. In this case, a message which includes an identification symbol of a service usage device may be sent from the service usage device when authentication is requested.

When an authentication request is received, the service provision server 100 references the user data database 150 and converts identification data of a service user into identification data within the communication server. In addition, the service provision server 100 sends a request to obtain this identification data and predicted location data via the communication server connection part 110 by the predicted location data acquisition part 130. In this way, the service provision server 100 can obtain predicted location data at the present time from among the schedule data of the terminal 400 using the communication server 300.

That is, in response to an acquisition request the terminal data management part 320 of the communication server 300 obtains predicted location data at the present time of the terminal 400 from the terminal data database 330 and sends the data to the service provision server 100. Furthermore, the communication server 300 may also confirm with the terminal 400 whether schedule data may be sent to the service provision server 100.

The service provision server 100 receives the schedule data via the communication server connection part 110. The authentication part 120 compares the received predicted location data of the terminal 400 and the location data of the service usage device 200 and verifies whether the predicted location data of the terminal 400 matches the location data of the service usage device 200.

Furthermore, what is meant by a match here is that a location shown as predicted location data of the terminal 400 and a location shown as location data of the service usage device 200 are within range of a distance set in advance as a threshold value. For example, in the case of a setting whereby authentication is successful if within a 500m range of the service usage device 200, then a judgment is made whether the location shown by the predicted location data of the terminal 400 is within the 500 m range of the service usage device 200.

In this way, it is possible to judge whether a service user is a user of the terminal 400. Usually, cases of lending the terminal 400 to another person are rare when the terminal 400 is a mobile phone, and because the user of the terminal 400 is usually fixed, it is possible to guarantee the identification of a service user. In addition, because it is not necessary to connected with the terminal 400 when performing authentication, it is possible to perform a guaranteed authentication of an identification correlated with the terminal 400 even if the terminal 400 is unable to communicate.

Furthermore, authentication using location data in the authentication part 120 may be used in combination with an authentication method using another security code.

In addition, it is possible to perform a process for converting identification data which identifies a service user within a service provision server into data which identifies a terminal or a user within a communication server using the communication server 300. Data which is result of correlating identification data which identifies a service user within a service provision server with data which identifies a terminal or a user within a communication server may also be stored in the terminal data database 330.

### Second Embodiment

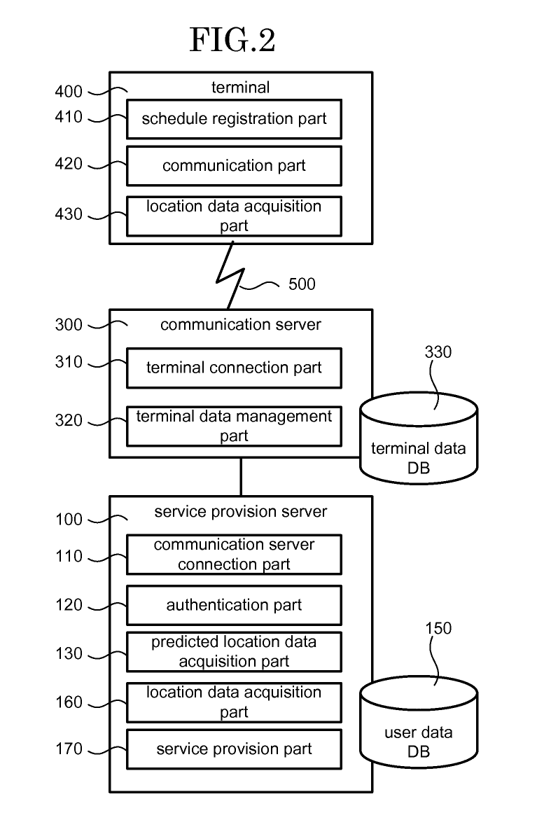

Next, a structure of the authentication system in another embodiment of the present invention is explained while referring to FIG. 2. Furthermore, explanations related to the same structure as the structure explained while referring to FIG. 1 are omitted.

In the present embodiment the terminal 400 functions as the service usage device 200 in FIG. 1. That is, it is possible for a service user to use a service via the terminal 400. For example, it is possible to consider the case where a service user conducts bank trading using internet banking from the terminal 400. The authentication part 120 in the embodiment related to FIG. 1 performed authentication by comparing the location data of the service usage device 200 and the predicted location data of the terminal 400. However, the authentication part 120 in the present embodiment performs authentication by comparing the present location data and the predicted location data of the terminal 400.

In the present embodiment the terminal 400 includes a location data acquisition part 430 in order to obtain present location data. In the terminal 400, the communication part 420 connects to another communication device and the location data acquisition part 430 obtains location data of the terminal 400 from the terminal 400 or the communication server 300.

That is, the terminal 400 may include a wireless LAN connection function in the communication part 420. In this way, MAC address data or radio field strength of a periphery wireless LAN installed device is obtained and the location data acquisition part 430 may obtain the location data of the present location of the terminal 400 by estimating the location of the terminal 400.

In addition, the location of the terminal 400 may be estimated by receiving a radio signal from a GPS satellite, or the location may be estimated by using location data and radio field strength of a base station used in the communication with the terminal 400. Furthermore, errors occur in the actual location of a terminal depending on the location estimation method used. As a result, it is preferred that a location estimation method is used which has as few errors as possible, and a location estimation method which obtains the MAC address data or radio field strength of a periphery wireless LAN installed device can be preferably used.

When the service provision server 100 receives a request for authenticating a service user from the terminal 400, present location data sent from the terminal 400 together with the authentication request from the terminal 400, or from a separate terminal 400 or the communication server 300 is received by the location data acquisition part 160. The authentication part 120 compares the present location data received by the location data acquisition part 160 and the predicted location data received by the predicted location data acquisition part 130 and verifies whether there is a match between the predicted location data and the present location data of the terminal 400.

If authentication by the authentication part 120 is successful, the service provision server 100 begins provision of a service to the terminal 400 in the service provision part 170. The service provision part 170 may be an application server for example.

### Third Embodiment

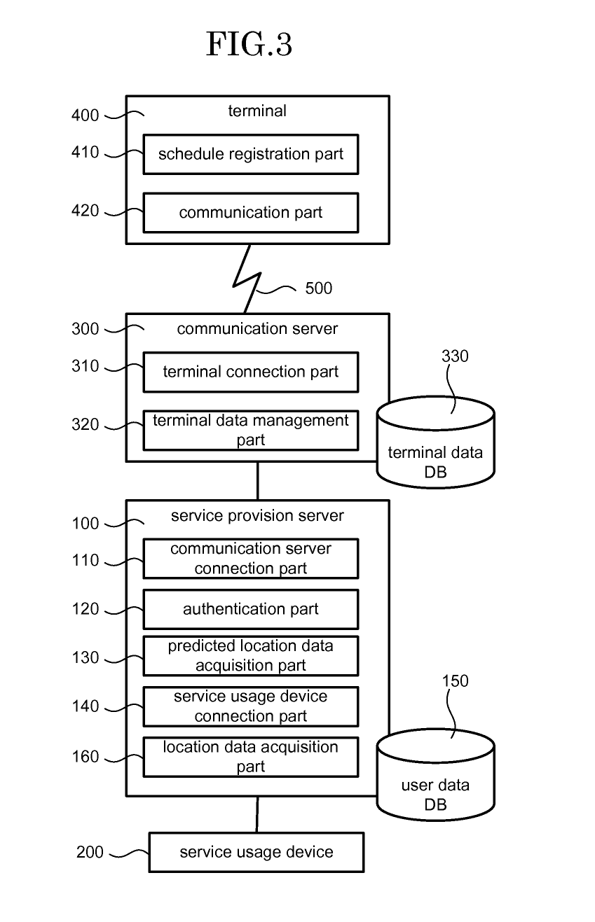

Next, the structure of the authentication system related to another embodiment of the present invention is explained while referring to FIG. 3. Furthermore, explanations related to the same structure as the structure explained while referring to FIG. 1 and FIG. 2 are omitted.

In the present embodiment, the location data acquisition part 160 explained while referring to FIG. 2 is added to the service provision server 100 of the embodiment related to FIG. 1. The authentication part 120 in the embodiment related to FIG. 1 performed authentication using the predicted location data of the terminal 400 and the location data of the service usage device 200. However, in the present embodiment the authentication part 120 performs authentication by using the present location data of the terminal 400 obtained by the location data acquisition part 160 and verifying whether the present location data and the predicted location data of the terminal 400 and the location data of the service usage device 200 match.

By using the present location data of the terminal 400 in addition to the predicted location data of the terminal 400 and the location data of the service usage device 200 it is possible to perform authentication with a greater guarantee of identification and a higher level of security.

Furthermore, as a modified example whereby the structure of the present embodiment is simplified, the service provision server 100 does not include the predicted location data acquisition part 130 and the authentication part 120 may perform authentication by verifying whether there is a match between the present location data of the terminal 400 and the location data of the service usage device 200. In this case, it is sufficient that the present location of the terminal 400 and the installment location of the service usage device be obtainable, the schedule registration part 410 in the terminal 400 becomes unnecessary, management of a schedule of the terminal 400 becomes unnecessary in the communication server 300, identification continues to be guaranteed to a certain degree and an authentication method which can be applied to a greater variety of terminals is provided.

### Fourth Embodiment

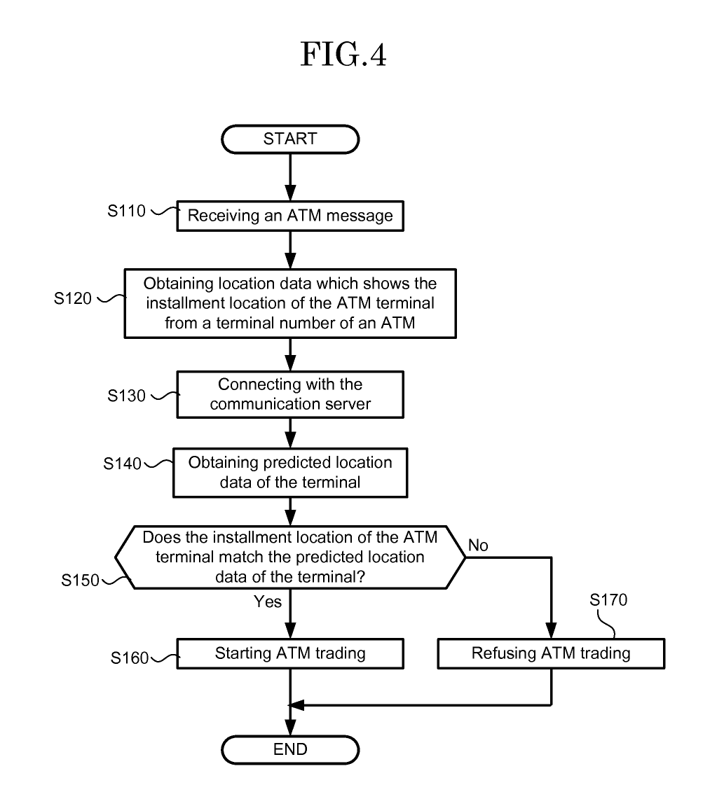

Next, an authentication method related to one embodiment of the present invention is explained while referring to FIG. 4. FIG. 4 is a flowchart for explaining the processes of the authentication method related to one embodiment of the present invention. FIG. 4 uses bank trading as an example and the case where an ATM terminal is used as the service usage device 200.

First, referring to FIG. 4, the service provision server 100 receives an ATM message which includes a trading request from the ATM terminal (S110).

When the ATM message is received, the service provision server 100 refers to a database and obtains location data which shows the installment location of the ATM terminal correlated with a terminal number from a terminal number of an ATM included in the message (S120).

The service provision server 100 connects with the communication server 300 via the communication server connection part 110 (S130) and predicted location data of the terminal 400 is obtained via the communication server connection part 110 by the predicted location data acquisition part 130 (S140).

The service provision server 100 verifies whether the location data which shows the installment location of the ATM terminal matches the predicted location data of the terminal 400 in the authentication part 120 (S150). In the case that the location data does not match as a result of the verification, that is, if the location in the predicted location data is not in the vicinity of the ATM installment location, then ATM trading is refused (S170). In the case where the location data matches, then ATM trading is started (S160).

In this way, by performing authentication using data registered from the terminal 400 as predicted location data, it is possible to correlate the terminal 400 with a user of the service user terminal and perform authentication in which identification is guaranteed.

### Fifth Embodiment

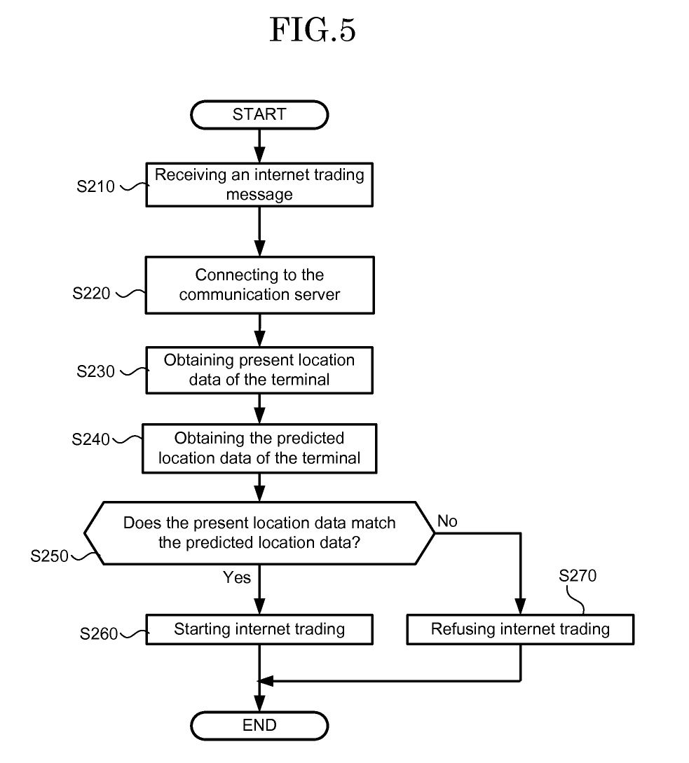

Next, an authentication method related to one embodiment of the present invention is explained while referring to FIG. 5. FIG. 5 is a flowchart for explaining the processes of the authentication method related to one embodiment of the present invention. FIG. 5 uses bank trading as an example and the case where an internet banking system is used from the terminal 400.

First, referring to FIG. 5, the service provision server 100 receives an internet trading message which includes a trading request from the terminal 400 (S210).

When the Internet trading message is received, the service provision server 100 connects to the communication server 300 via the communication server connection part 110 (S220) and obtains present location data of the terminal 400 (S230). Furthermore, unlike this, the present location data of the terminal 400 may also be included in the Internet trading message sent from the terminal 400.

The service provision server 100 connects with the communication server 300 via the communication server connection part 110 and obtains the predicted location data of the terminal 400 via the communication server connection part 110 by the predicted location data acquisition part 130 (S240).

The service provision server 100 verifies whether the present location data matches the predicted location data of the terminal 400 in the authentication part 120 (S250). In the case that the location data does not match as a result of the verification, that is, if the location in the predicted location data is not in the vicinity of location shown by the present location data, then Internet trading is refused (S270). In the case where the location data matches, then internet trading is started (S260).

In this way, it is possible to perform authentication using predicted location data registered from the terminal 400 and present location data of the terminal 400. As a result, it is possible to prevent Internet trading by an impersonating third party and perform internet trading where identification is guaranteed.

### Sixth Embodiment

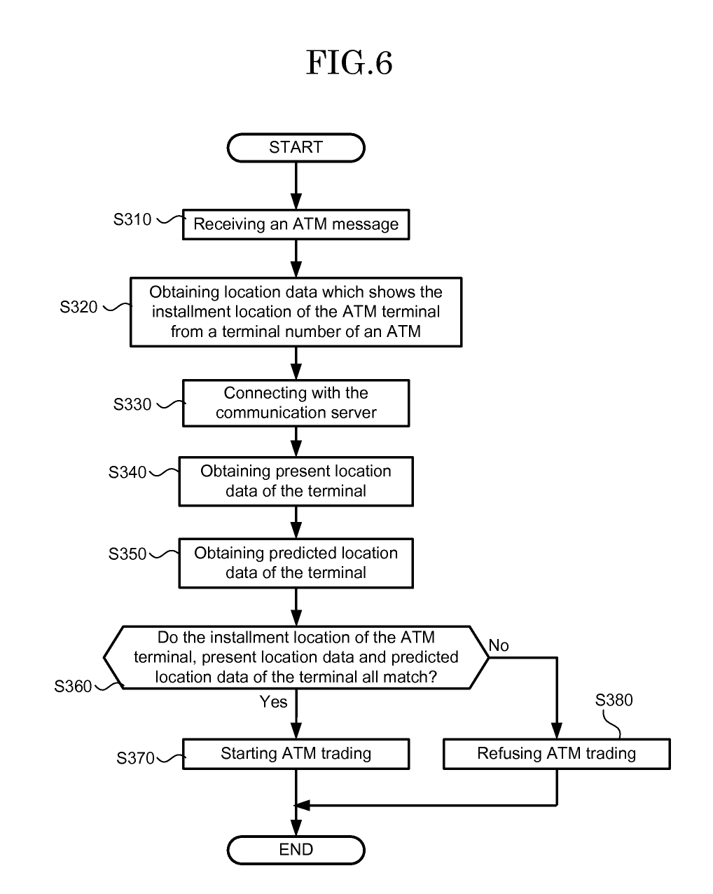

Next, an authentication method related to one embodiment of the present invention is explained while referring to FIG. 6. FIG. 6 is a flowchart for explaining the processes of the authentication method related to one embodiment of the present invention. In FIG. 6 a step for obtaining present location data of a terminal is further added to the authentication method explained while referring to FIG. 4, and authentication is performed by verifying whether present location data, predicted location data of a terminal and data which shows the installment location of an ATM terminal match.

First, referring to FIG. 6, the service provision server 100 receives an ATM message which includes a trading request from the ATM terminal (S310).

When the ATM message is received, the service provision server 100 refers to a database and obtains location data which shows the installment location of the ATM terminal correlated with a terminal number from a terminal number of an ATM included in the message (S320).

Next, the service provision server 100 connects with the communication server 300 via the communication server connection part 110 (S330) and present location data of the terminal 400 is obtained (S340). Furthermore, unlike this, present location data of the terminal 400 may also be obtained directly from the terminal 400.

The service provision server 100 obtains predicted location data of the terminal 400 via the communication server connection part 110 by the predicted location data acquisition part 130 (S350).

The service provision server 100 verifies whether the location data which shows the installment location of the ATM terminal, present location data and predicted location data of the terminal 400 all match in the authentication part 120 (S360). In the case that all the location data do not match as a result of the verification, that is, if the location in the present location data or predicted location data of the terminal 400 is not in the vicinity of the ATM installment location, then ATM trading is refused (S380). In the case where the location data matches, then ATM trading is started (S370).

In this way, it is possible to perform authentication using present location data of the terminal 400, predicted location data registered from the terminal 400 and installment location data of the ATM terminal. As a result, it is possible to prevent internet trading by an impersonating third party and perform internet trading where identification is more strongly guaranteed.

Furthermore, as a modified example whereby the authentication method related to the present embodiment is simplified, the service provision server 100 does not obtain predicted location data of the terminal 400 authentication may be performed by verifying whether there is a match between the present location data of the terminal 400 and the location data which shows the installment location of the ATM terminal. In this case, it is sufficient that the present location of the terminal 400 and the location data which shows the installment location of the ATM terminal be obtainable, the schedule registration part in the terminal 400 becomes unnecessary, management of a schedule of the terminal 400 becomes unnecessary in the communication server 300, and as a result identification continues to be guaranteed to a certain degree and an authentication method which can be applied to a greater variety of terminals is provided.

What is claimed is:

1. An authentication system comprising:
a movable terminal;
a communication server connected with the movable terminal by wireless communication managing predicted location data of the movable terminal:
a service usage device allowing a service provider to provide a service to a user of the movable terminal; and
a service provision server connected with the service usage device and the communication server and managing location data of the service usage device;
wherein
the service provision server includes;
a service usage device connection part connected with the service usage device and receiving an authentication request from the user and installment location data of the service usage device from the service usage device;
a communication server connection part communicating with the communication server;
a predicted location data acquisition part obtaining predicted location data from the communication server;
a user data database storing terminal identification data of the user, the user being a service user; and
an authentication part performing authentication based on the installment location data and the predicted location data in response to the authentication request.

2. The authentication system according to claim 1, wherein the predicted location data is a predicted location in a predetermined time period of the movable terminal.

3. The authentication system according to claim 1, wherein the movable terminal includes a registration part registering the predicted location data in advance by an input of a user of the movable terminal.

4. An authentication system comprising:
a movable terminal obtaining present location data;
a communication server connected with the movable terminal by wireless communication managing predicted location data of the movable terminal: and
a service provision server connected with the communication server;
wherein
the service provision server includes;
a service provision part receiving an authentication request from a user and providing a service to the user;
a location data acquisition part obtaining the present location data of the movable terminal;
a communication server connection part communicating with the communication server;
a predicted location data acquisition part obtaining predicted location data from the communication server;
a user data database storing terminal identification data of the user, the user being a service user; and
an authentication part performing authentication based on the installment location data and the predicted location data in response to the authentication request.

5. The authentication system according to claim 4, wherein the predicted location data is a predicted location in a predetermined time period of the movable terminal.

6. The authentication system according to claim 4, wherein the movable terminal includes a registration part registering the predicted location data in advance by an input of a user of the movable terminal.

7. The authentication system according to claim 4, wherein the movable terminal obtains location data of the present location via communication with a wireless LAN device.

8. An authentication system comprising:
a movable terminal obtaining present location data;
a communication server connected with the movable terminal by wireless communication;
a service usage device allowing a service provider to provide a service to a user of the movable terminal; and
a service provision server connected with the service usage device and the communication server and managing location data of the service usage device;
wherein
the service provision server includes;
a service usage device connection part connected with the service usage device and receiving an authentication request from the user and installment location data of the service usage device from the service usage device;
a location data acquisition part obtaining the present location data of the movable terminal;
a communication server connection part communicating with the communication server;
a user data database storing terminal identification data of the user, the user being a service user; and
an authentication part performing authentication based on the installment location data and the predicted location data in response to the authentication request.

9. The authentication system according to claim 8, wherein the communication server manages predicted location data of the movable terminal, the service provision server includes a predicted location data acquisition part obtaining the predicted location data from the communication server, and the authentication part performs authentication based on the present location data, the installment location data and the predicted location data.

10. The authentication system according to claim 9, wherein the movable terminal includes a registration part registering the predicted location data in advance by an input of a user of the movable terminal.

11. The authentication system according to claim 8, wherein the movable terminal obtains location data of the present location via communication with a wireless LAN device.

12. A service provision server connected with a communication server managing predicted location data of a terminal and a service usage device allowing a service provider to provide a service to a user of the terminal, comprising:
a service usage device connection part communicating with the service usage device and receiving an authentication request from the service usage device and installment location data of the service usage device;
a communication server connection part communicating with the communication server;
a predicted location data acquisition part obtaining predicted location data from the communication server;
a user data database storing terminal identification data of the user, the user being a service user; and
an authentication part performing authentication based on the installment location data and the predicted location data in response to the authentication request.

13. The service provision server according to claim 13, wherein the predicted location data is data registered in advance by a user of the terminal.

14. A service provision server connected with a communication server and managing predicted location data of a terminal, comprising:
a service provision part receiving an authentication request from the terminal of a user and providing a service to the user of the terminal;
a location data acquisition part obtaining the present location data of the terminal;
a communication server connection part communicating with the communication server;
a predicted location data acquisition part obtaining predicted location data from the communication server;
a user data database storing terminal identification data of the user, the user being a service user; and
an authentication part performing authentication based on the present location data and the predicted location data in response to the authentication request.

15. The service provision server according to claim 14, wherein the predicted location data is data registered in advance by a user of the terminal.

16. A service provision server connected with a communication server and managing present location data of a terminal and a service usage device allowing a service provider to provide a service to a user of the terminal, comprising:
a service usage device connection part communicating with the service usage device and receiving an authentication request from the service usage device and installment location data of the service usage device;
a communication server connection part communicating with the communication server;
a location data acquisition part obtaining the present location data from the communication server;
a user data database storing terminal identification data of the user, the user being a service user; and
an authentication part performing authentication based on the installment location data and the present location data in response to the authentication request.

17. The service provision server according to claim 16, further comprising:
a predicted location data acquisition part obtaining predicted location data from the communication server;
wherein
the authentication part performs authentication based on the present location data, the installment location data and the predicted location data.

18. The service provision server according to claim 17, wherein the predicted location data is data registered in advance by a user of the terminal.
